(19) United States
(12) Patent Application Publication
(10) Pub. No.: US 2024/0135198 A1
(43) Pub. Date: Apr. 25, 2024

(54) Network Machine Learning (ML) Model Feature Selection

(71) Applicant: Ciena Corporation, Hanover, MD (US)

(72) Inventors: Raghuraman Ranganathan, Bellaire, TX (US); Nigel Davis, Edgware (GB); Lyndon Y. Ong, Sunnyvale, CA (US); David K. Bainbridge, Summerville, SC (US)

(21) Appl. No.: 17/968,966

(22) Filed: Oct. 18, 2022

(51) Int. Cl. G06N 5/02

(52) U.S. Cl. CPC G06N 5/022

(57) ABSTRACT

The present disclosure relates to systems and methods for ML model feature selection and transformation. Specifically, the system and method Include receiving information and data from a network having resources; implementing feature selection on one or more network Machine Learning (ML) models, such that each is a pipeline of a plurality of functions to control the resources and with specified interfaces to other control applications; utilizing one or more feature graph engines (FGEs) which creates one or more feature graphs, from the information and data, as a functional component to derive a design-time set of feature vector for a specific context, each feature graph represents network layer representations in the network which includes multiple layers; and implementing changes to the one or more feature graphs based on any run-time updates from the pipeline.

### FIELD OF THE DISCLOSURE

The present disclosure generally relates to autonomous networking. More particularly, the present disclosure relates to systems and methods for network machine learning (ML) model feature selection.

### BACKGROUND OF THE DISCLOSURE

The operations of networks including mobile, internet of things (IoT), fixed has been evolving based on the recent advances in various technologies such as machine intelligence and robotics. The network framework includes sensors, actuators, compute servers, and communication networks. The next generation service and network architecture is evolving with a combination of connect, compute, sense, store, and act resources, and specifically for a Self-Optimizing Fabric (SOF) architecture. The SOF can be viewed as an assembly of heterogenous components, systems, and fabric contributed by producers and consumers for an end-to-end intelligence fabric optimized to meet the overall objectives of business collaboration [Reference U.S. Pat. No. 11,184,234 B2]. The network architecture with the SOF includes a combination of heterogenous systems providing control patterns of Sense, Discern, Infer, Decide, and Act (SDIDA) [Reference U.S. Pat. No. 11,184,234 B2].

Machine learning is the scientific study, design and development of computer algorithms that can improve a system without using explicit instructions, through experience and using data from the system. Machine learning is a sub-set of artificial intelligence (AI) which creates and uses models based on sample data, otherwise called training data, to make predictions and decisions automatically. In machine learning, features are the characteristics, attributes or properties for the entities of a system being evaluated. For example, the features for a network would be the characteristics or attributes associated with the entities such as connect, interface, or a function and can include components such as a switch, router, or firewall. Feature values for the attributes, such as for the color of a pixel in an image or switch egress port queue depth, are the data from the entities that can be, for example, a time series or a static value or a Boolean state. The quality of the features in the dataset have impact on the quality of the output of the model. A ML model is only as good as the features it is trained on, therefore, techniques and methods for feature selection and feature importance are crucial. The goal of feature engineering is for the model to learn a pattern between the inputs and the target variable such that when new data is received where the target value is not known the model can predict the target value, wherein, improving the quality of the results from the ML model. Feature selection can improve the accuracy at which the ML model is able to predict new data and reduce computational cost, however, challenges exist as the techniques can be time consuming and complex as feature selection is unique to the underlying data.

### BRIEF SUMMARY OF THE DISCLOSURE

The present disclosure relates to systems and methods for ML model feature selection and transformation. Specifically, the system and method presented receives information from a network system having resources and implements optimal feature selection on one or more network ML models, such that each is a pipeline of a plurality of functions to control resources and with specified interfaces to other control applications. In lieu of a statistical approach to derive a design-time set of features for a specific service behavior, the present disclosure uses information and data models with one or more Feature Graph Engines (FGEs) to minimize extraneous/redundant data needed, reduce resources required for ML model optimization, avoid complex analysis without knowing relationships, and provide better performance with lower cost and power.

In various embodiments, the present disclosure can include a method having steps, a processing device configured to implement the steps, and a non-transitory computer-readable medium having instructions stored thereon for programming a device for performing the steps. The steps include receiving information and data from a network having resources; implementing feature selection on one or more network Machine Learning (ML) models, such that each is a pipeline of a plurality of functions to control the resources and with specified interfaces to other control applications; utilizing one or more feature graph engines (FGEs) which creates one or more feature graphs, from the information and data, as a functional component to derive a design-time set of feature vector for a specific context, each feature graph represents network layer representations in the network which includes multiple layers; and implementing changes to the one or more feature graphs based on any run-time updates from the pipeline.

The plurality of functions can include sensing, discerning, inferring, deciding, and causing the actions (SDIDA). The ML model can be utilized in the SDIDA pipeline embedded within a controller application. The steps can further include optimizing feature selection to include policies including limits for those features when mapped to a ML model for analytics on data related to network services. The steps can further include leveraging the information and data for network services and resources including business and network policies to create and use the one or more feature graphs for feature selection. The network can include a plurality of virtual or physical network function elements with links to form various types of network topologies. The steps can further include performing the utilizing with the information and data for a given service intent and its resources. The one or more feature graphs can include the relative weights to indicate the importance of the features in the ML model. The steps can further include one or more of receiving governance change updates and receiving feature vector updates by the plurality of functions.

### BRIEF DESCRIPTION OF THE DRAWINGS

The present disclosure is illustrated and described herein with reference to the various drawings, in which like reference numbers are used to denote like system components/process steps, as appropriate, and in which:

FIG. 1 is a block diagram showing a SDIDA pipeline with an ML model and a block diagram of a SDIDA control system providing control of governed systems.

FIG. 2 is a block diagram depicting an approach for feature selection utilizing a governed system with an autonomous control application for analytics.

FIG. 3 is an example network service across a multi-layer/multi-domain network.

FIG. 4 is an example forwarding domain view for a specific observer.

FIG. 5 is an example EVP-LAN service as a network service intent for a customer connecting three sites with EVC Endpoints (EVC EPs).

FIG. 6 is an example model with relationships between attributes.

FIG. 7 shows the method with a logical architecture for feature selection to set up one or more SDIDA pipeline(s) within autonomous control application(s).

FIG. 8 shows an example array with feature vector and weights at an EVC EP.

FIG. 9 is a flowchart of a process for network ML model feature selection.

### DETAILED DESCRIPTION OF THE DISCLOSURE

In various embodiments, the present disclosure relates to systems and methods for network ML model feature selection. Specifically, the system and method presented receives information from a network system having resources and implements optimal feature selection on one or more network ML models, such that each is a pipeline of a plurality of functions to control resources and with specified interfaces to other control applications. In lieu of a statistical approach to derive a design-time set of features for a specific service behavior, the present disclosure uses information and data models with one or more Feature Graph Engines (FGEs) to minimize extraneous/redundant data needed, reduce resources required for ML model optimization, avoid complex analysis without knowing relationships, and provide better performance with lower cost and power

### Features for a Sense Function

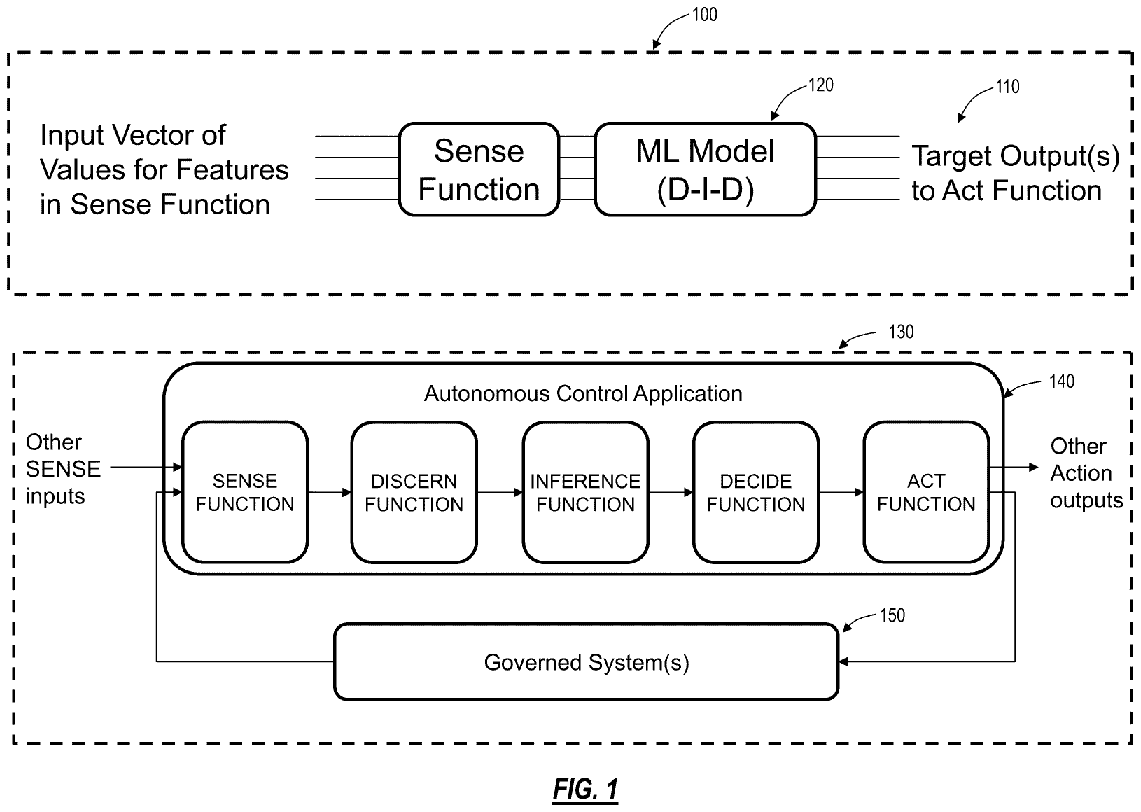

FIG. 1 shows a SDIDA (Sense, Discern, Infer, Decide and Act) pipeline 100, with an ML model having multiple input vectors of values for the features of a system (or component of a system) under evaluation that are mapped to and, thus, predict a target output 110 as the most likely state of the system (or component of the system). The target output 110 could then be used by an Act Function to apply updates to the state of the system (or component of the system). The ML model 120 is trained to recognize some pattern in the values for the features and such a trained model is then used during system run time with new input values to perform inference and predict with some accuracy the target output.

130 is a diagram of a control application 140 with a SDIDA pipeline for providing control of governed systems 150. The control application 140 can be implemented through the controllers and the governed systems 150 can include the controlled entities. The control application for analytics includes a pipeline of functions including Sense, Discern, Infer, Decide and Act (SDIDA) functional components with link(s) between these components for transfer of information between these components. Additional link(s) (not shown in 130) could be used to influence, e.g., with weights, the information that is used by a component. The output of a given SDIDA pipeline would then be used to govern the actions of some or all aspects of a controlled system or systems 150.

Each function in the SDIDA pipeline 100 can receive one or more vectors as inputs, i.e., a list [x₁, x₂, x₃ . . . xⱼ], for example, and provide one or more vectors as outputs, i.e., a list [y₁, y₂, . . . yₖ], for example. A network pipeline architecture refers to the continuous and overlapped movement of instructions or arithmetic steps taken by the processor to perform an instruction. In general, for a pipeline, some or all the inputs to the pipeline can come from the Governed System, or from a peer distributed control application, a higher-level distributed control application, or an outside source. The data along with any additional metadata may be asynchronous and indicate some inter-relationship for further processing by the pipeline. U.S. patent application Ser. No. 16/849,129 describes the East-West, North-South and recursive interconnection of SDIDA systems in general broad terms.

The SENSE function is to detect the current configuration, operational, or other necessary information by capturing the data relevant for the pipeline. This may include pre-processing the data to a suitable format for further processing by the pipeline. For example, in a packet transport network, this function could collect the 5-tuple (a set of five different values that comprise a TCP/IP connection) of packet header information for packet flows or reading the counter values for the packets in a packet flow that are declared green or yellow or red by a policer in a network element or the billing information from a Business Support System (BSS) for a particular customer's packet traffic in the network.

The DISCERN function is to identify a pattern in the current state. For example, in a packet transport network, this function could identify the presence or absence of a particular unique signature either in the packet header and/or in the payload in a specific packet flow during specific periods in time. The DISCERN function can be rule-based, via heuristics, via machine learning, as well as combinations thereof.

The INFER functions are to conclude, for example, on the type of pattern in current state. For example, in a packet transport network, this function could determine whether some unique signature in the packet flow from a given source address corresponds to an anomaly. The Autonomic Controller could be but is not limited to using Artificial Intelligence (AI)/Machine Learning ML models in which case the INFER Function could use Supervised, Unsupervised or Reinforcement Learning Methods.

Supervised learning models include algorithms which learns on a labeled dataset. A supervised learning algorithm analyzes the training data and produces an inferred function which can be used to map new examples. Unsupervised learning models include algorithms which learn patterns from untagged data. Unsupervised learning methods self-organize and during the training phase attempt to mimic the data and use error in the model output to correct itself. Reinforcement learning models do not need labeled datasets but include reward-oriented algorithms which learn how to achieve a goal over many steps. The purpose of reinforcement learning is for the agent to learn the optimal policy that maximizes the reward function.

The DECIDE function is to determine the target state. For example, in a packet transport network, this function could determine that the packet flow needs a new Access Control List (ACL) entry to filter the flow in the network element where the packet flow enters the network. As part of the DECIDE Function there may be constraints introduced on the actions that can be taken based on system conditions.

The ACT function is to change the configuration and/or operational state of entities with the pipeline providing some actions [a₁, a₂, . . . aₙ] to be taken on the Governed System(s). For example, in a packet transport network, this function could apply the ACL entry in a set of ports of a specific network element where the anomalous traffic is to be filtered by the network.

To infer the state of the system (or component of the system) with high accuracy, determining the right set of features to both train the model and use during the inference stage is one critical step. The inference stage of ML is the process of using a trained, for example, Graph Neural Network (GNN) or other, models, to make predictions based on the data to produce the desired result. Additionally, for efficient performance of the ML model, feature selection and/or transformation might be necessary.

Machine Learning Operations (MLOps) is a core function of ML engineering focused on deploying and maintaining ML models in production reliably and efficiently. ML models are tested and developed and when an algorithm is ready to be launched MLOps is practiced and seeks to increase automation and improve the quality of models. As part of MLOps, the feature selection and transformation process could be one aspect in the steps to modify the SENSE function as part of a governance process to set up and operate SDIDA pipeline(s) [See U.S. patent application Ser. No. 17/389,775, filed Jul. 30, 2021, and entitled “Governance and interactions of autonomous pipeline-structured control applications, the contents of which are incorporated in their entirety]. While the feature set is one input to the SENSE function, the actual data for each of the features come from the governed system as another input to the SENSE function.

The set of features could be large and include contexts related to various business intents. An example can include a financial enterprise with per site and/or per user usage and security restrictions, and various network service intents in a multi-layer and multi-domain network, e.g., delay variation over certain time intervals measured for conditional delivery of a specific 5-tuple multicast packet flow across some restricted subset of Segment Routed (SR) based Multiprotocol Label Switching (MPLS) tunnel topology of an optical mesh network spanning terrestrial and submarine domains.

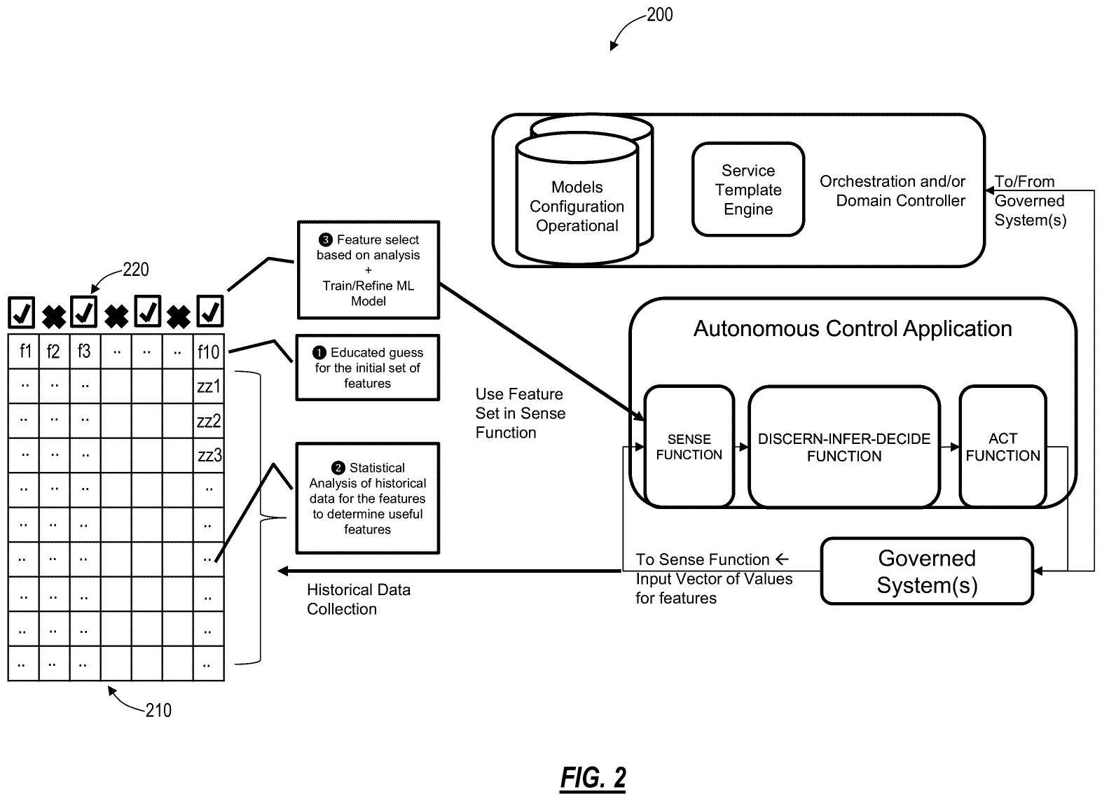

FIG. 2 shows a governed system with an autonomous control application for analytics and an orchestration or domain controller to configure them per the service template 200. The orchestration and/or domain controller is shown only with relevant components but can include other components as described herein. Before a SDIDA pipeline can analyze the data from the governed system, the historical data from the system needs to be evaluated with analysis and training to determine and/or refine the feature set that would be useful for the SENSE function. As example, the table 210 shows a feature vector as a row heading (f1, f2 . . . f10) and the columns with the historical data (xᵢ, yᵢ . . . zzᵢ where i=1, 2 . . . n) for each of the features collected as a function of time. Analysis might then result in a subset of features that might be useful and is shown with check marks at the top of the table 220.

Current industry standard feature selection methods could be manual where a subject matter expert makes an educated guess or performs repeated ML model training attempts, with one or many different ML models, using smaller or different sets of features in each subsequent attempt. Alternatively, various statistical techniques could be used to select features with minimal correlation or within some variance threshold, etc. to determine the relevant features for a specific behavior of interest.

The novel aspect disclosed is the use of Information and Data Models with a Feature Graph Engine (FGE) instead of a statistical approach to derive a design-time set of features for a specific service behavior. This approach assists to minimize extraneous/redundant data needed, reduce resources required for ML Model optimization, avoid complex analysis without knowing relationships, and provides better performance with lower cost and power. An additional aspect of this method includes changes to the feature set based on any of the run-time updates from the SDIDA pipeline.

### Features of Interest

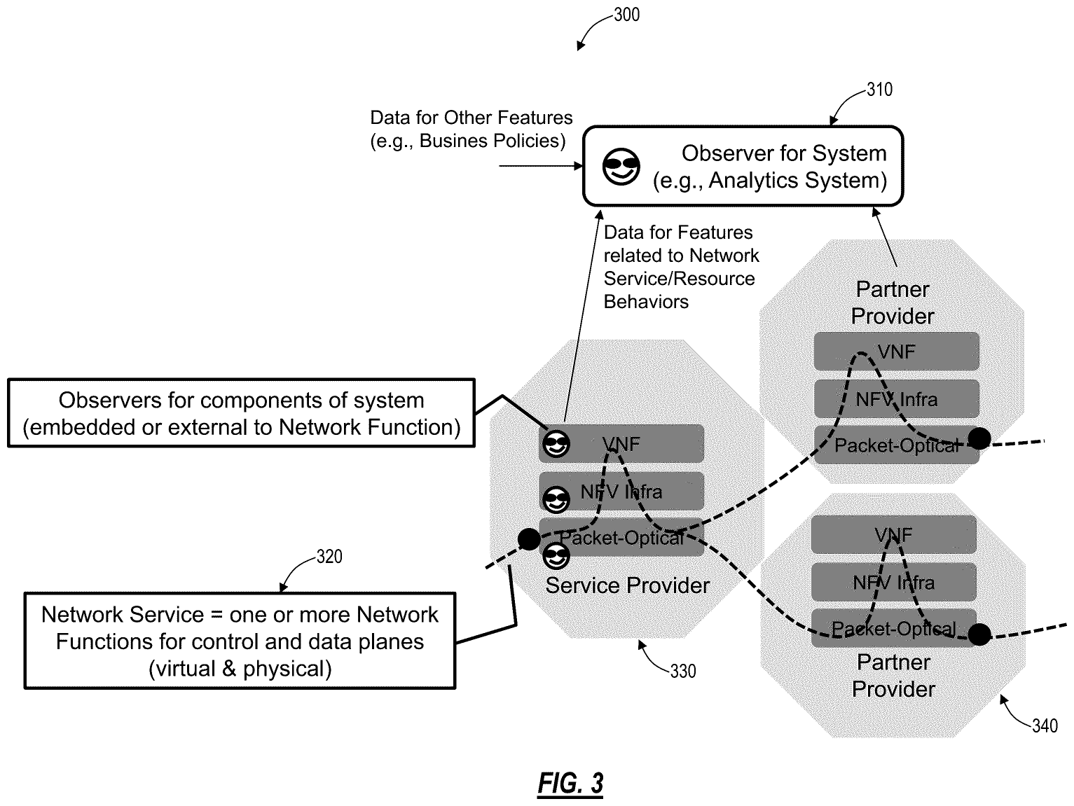

FIG. 3 shows the features of interest for the network service intents in a multi-layer network of a Service Provider (SP) domain 330 or with multiple domains such as across other Partner Provider network(s) 340. The features of interest can include the associated resources as seen by an observer 310 (e.g., analytics system with a SDIDA pipeline) external to or as part of the system, i.e., embedded software, or a component of the system. Note that when the system being evaluated is a network element, then a pluggable optical port is a component of that system. The system could be a virtual or a physical network function element or a network of many virtual and/or physical network function elements with links to form various types of topologies such as overlay and/or underlay networks 320. Network topologies can include mesh, ring, star, or others. The feature set and the relationships between the features would need to consider the mesh of function chain(s) in the network service and the specific context being evaluated by an observer's SDIDA pipeline.

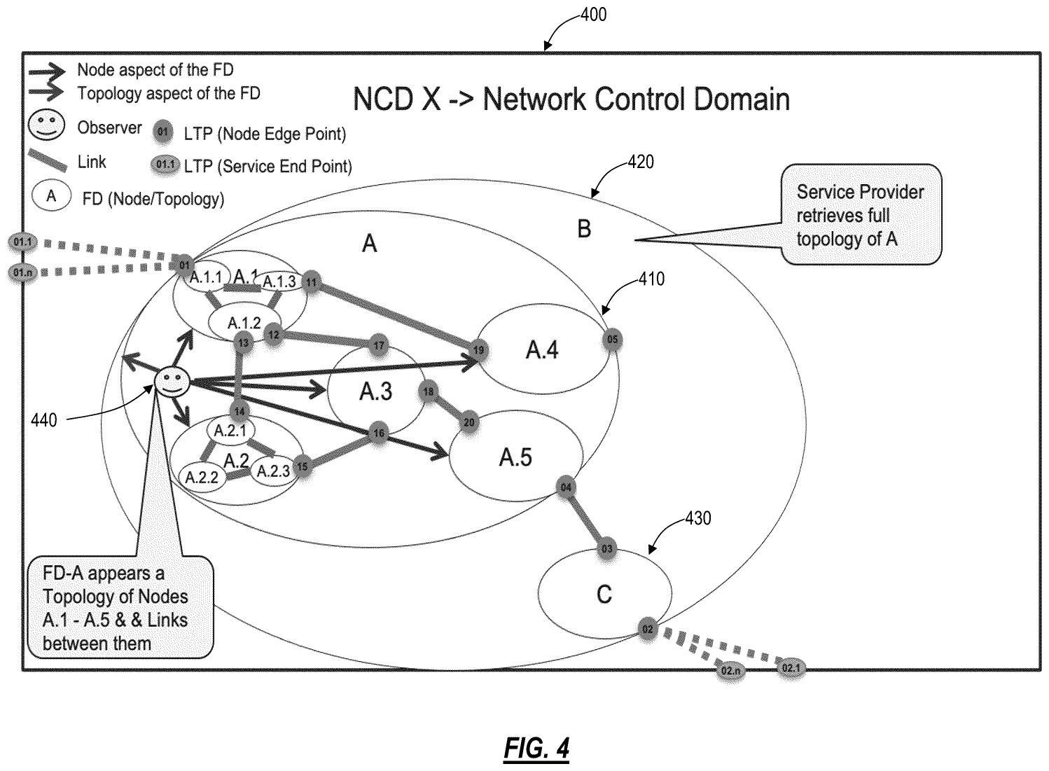

Some behaviors may be observed recursively by different observers at each level in the hierarchy by decomposing a system to its components. For example, connection behaviors of different scope could be sensed for nested Forwarding Domains (FD) such as a network domain, sub-network, network element, line card switch, or a physical or virtual function. FIG. 4 shows a Network Control Domain 400 with multiple FDs (A [410], B and C [430]) as different sub-network domains with the scope and depth of detail being different for different observers 440. A network service is shown with Service End Points at Logical Termination Points (LTPs) Dx.y (D1.1, D1.n, D2.1, D2.n) and is mapped via Node Edge Points across FDs (A [410], B and C [430]). An observer 440, i.e., SP's analytics system, is shown to have a view of the topology of FD A 410 with nodes A.1 to A.5 and the links between them. Such an observer 440 can thus retrieve the full topology of A 410 and the connection behaviors across the entire topology or a subset of the topology such as a node or link.

Furthermore, the observer 440 for each of these different scopes could be the same or different SDIDA pipelines in one or different controller applications for analytics and, if multiple pipelines exist, they could be interacting with each other to share state information. The feature selection and/or transformation for these interacting pipelines may need to be coordinated in a federated approach to have performant ML models in each of these pipelines. Note though that it is possible that the different observers may have limitations in what they can observe due to encapsulation/de-encapsulation processes and/or encryption or other business policies applied to the features being sensed. Thus, the feature set and the relationships between the features for each observer might need pruning or augmenting depending on operational policies for the observers.

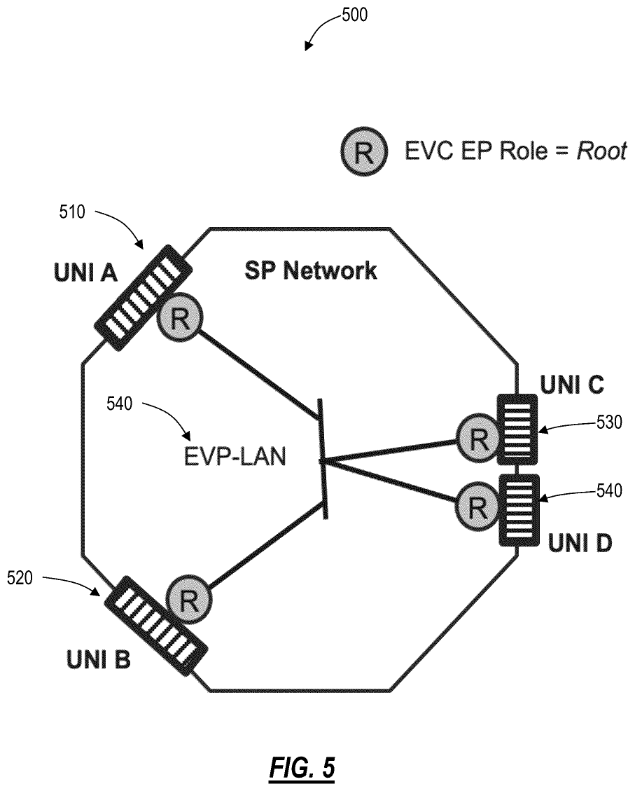

Consider, for example, FIG. 5 which depicts an Ethernet Virtual Private Local Area Network (EVP-LAN) service 540 (Reference: MEF 6.3 “Subscriber Ethernet Services Definition”) as a network service intent for a customer connecting three sites with Ethernet Virtual Connection End Points (EVC EPs), correlating to the location of LTP Service End Points in FIG. 4, at User Network Interfaces UNIs A (510), B (520), C (530) and D (540).

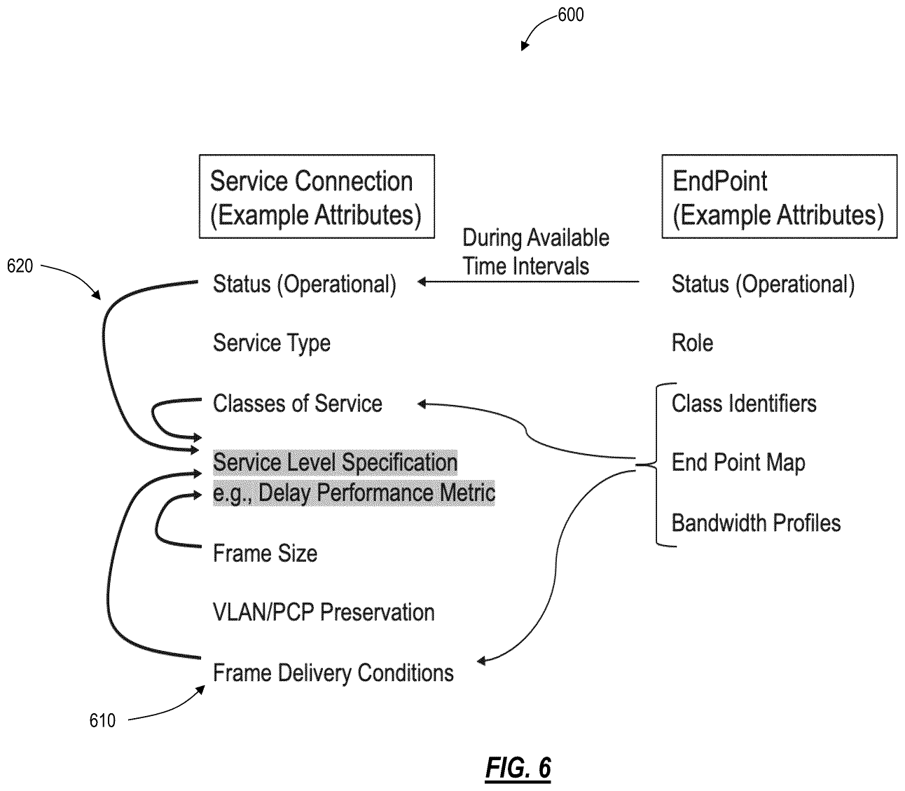

Some behaviors for this intent service 500 can be observed and measured by the customer's as well as SP's analytics systems, e.g., EVC EP Role of Root with the ability to send/receive from other EVC EPs in the service, or conditional multicast frame delivery of some burst sizes between a specific pair of Root EVC EPs. Some other behaviors, e.g., frame forwarding or queueing issues at a dedicated or shared resource within SP Network, would be observable by the SP's analytics system but not explicitly, e.g., the specific cause of queueing delay, by the customer of the service. Additionally, many service-related features such as frame size distribution, frame types in the class of service, security aspects with Access Control Lists (ACLs), classifiers via EVC EP Map, number of endpoints, conditions for frame delivery, bandwidth profile settings with token sharing among traffic classes, protocol parameters for Operations, Administration, and Maintenance (OAM) or Layer 2 control protocols (L2CP), link and/or topology constraints, etc. could all influence the pattern in a time series of delay values for a particular packet flow. These related behaviors also highlight the need to consider the relationship among the different features of a network service as an important consideration in feature selection. As shown in FIG. 6 for an example service behavior with delay performance metric in a Service Level Specification attribute 600, the relationship among the features could be constraints to feature selection for a given intent context. Such relationships are captured as requirements in industry specifications such as, for example, MEF 10.4 “Subscriber Ethernet Service Attributes”.

The service and resource behaviors and the limits to the behaviors would be specified in information and data models with the attributes and parameters for the service model. For example, a connectivity service like an IP or Ethernet Service with a Service Level Specification (SLS), and/or, a resource model such as a Flow Point with classifier or bandwidth meter or a protocol. The attributes may be grouped in a meaningful way such as interface vs connection vs protocol, etc. and can be generalized for use across layers or specialized for a layer in a multi-layer network. For example, YANG data models for MEF specification Ethernet Services (MEF 6.2, MEF 10.3, and MEF 58) capture the attributes and relationships for the various service behaviors specified in other specifications.

The feature set selection for a behavior would be a subset of the attributes and the parameters in the various models relevant for a given service and customer context. These models capture the relationships, as shown in FIG. 6, between the managed objects with certain sections of the model being conditional on support or being valid in the system. Additionally, constraints on certain attributes and parameters may be specified with conditional statements referring to the values and limits for other attributes and this would likely be specified in data models. Both the information and data models could be relevant since some of the features could be specific to the implementation such as Ethernet vs MPLS vs IP vs Optical. The parameter values would also be policy or bounds for the behavior(s) associated with the selected feature. FIG. 6 can be viewed as a hand drawn feature graph where the attributes 610 represent the vertices and lines 620 represent the links. The weights could be the relative importance of that feature in the context of the model.

While many models might be industry standards such as from ITU-T, BBF, IETF, etc. and/or open-source organizations such as Linux Foundation, and Open Networking Foundation (ONF) some of the models could be vendor proprietary to capture hidden dependencies via requirements in industry protocol specifications. There could be additional information in configuration (design-time) and operational (run-time) network state for control and data plane models from Operational Support Systems (OSS) and Network Operating Systems (NOS). Furthermore, Business Support Systems (BSS) may also provide models for customer information, inventory, etc.

### Features Selection/Transformation

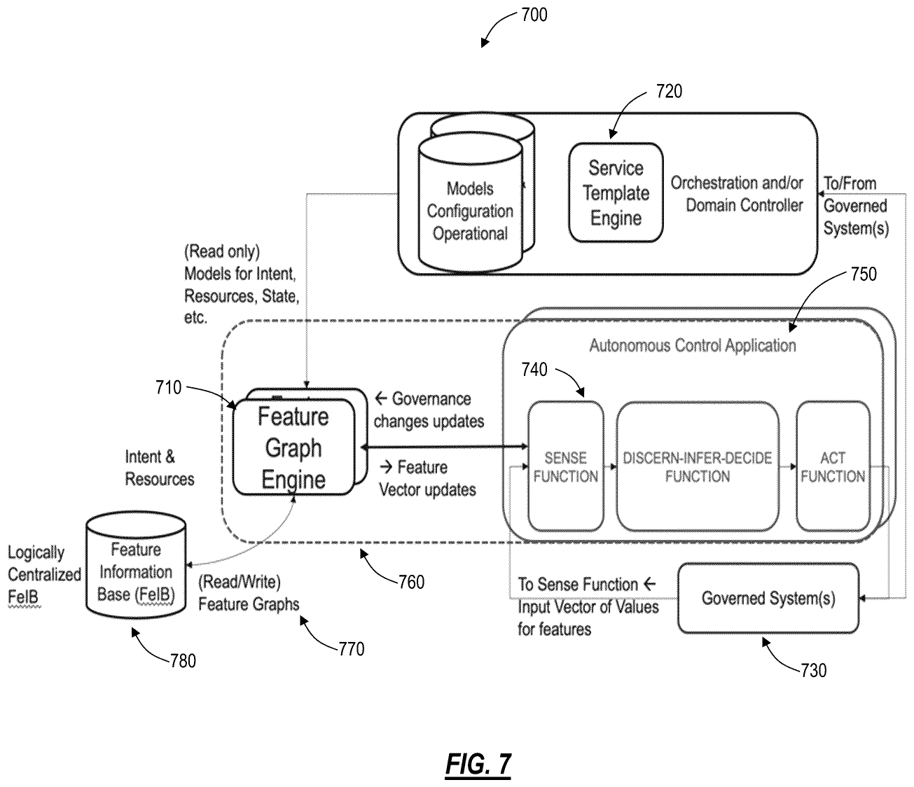

FIG. 7 shows the method with a logical architecture for feature selection to set up one or more SDIDA pipeline(s) within autonomous control application(s) 700.

A Feature Graph Engine (FGE) 710 determines the feature sets and builds the feature graphs for the relationships within each feature set using the information and data models for a given service intent and its resources including operational state. A feature graph is a structure used to model relations between objects and is made up of vertices (or nodes) and links (or edges). The service intent and resources information are provided by a Service Template Engine 720 that computes the network resources and the configuration state to deploy for a given service intent that has been provided by other Business Support Systems (BSSs) not shown in 700. Note that some of the configuration and operational information, including which features are supported, could come from the Network Operation System (NOS) embedded in the governed system(s) 730. As sources (dependencies) utilized by the FGE 710 to generate a feature graph are modified, the FGE 710 could be triggered to regenerate the feature graph and apply it to the Sense functions 740. The feature graph could include the relative weights as initial seed to indicate the importance of the features in the ML model.

There can be one or more FGEs 710, such as one per service type or network technology layer or other ways to distribute the workload. FGEs can be part of or separate from the autonomous control application 750 that hosts the SD IDA pipeline(s) as shown by the dashed box outline 760. In one example implementation, a publish/subscribe messaging architecture in an out-of-band management network could be used for updates between the FGE and the SDIDA pipeline as well as for the interactions between the governed system and the SDIDA pipeline.

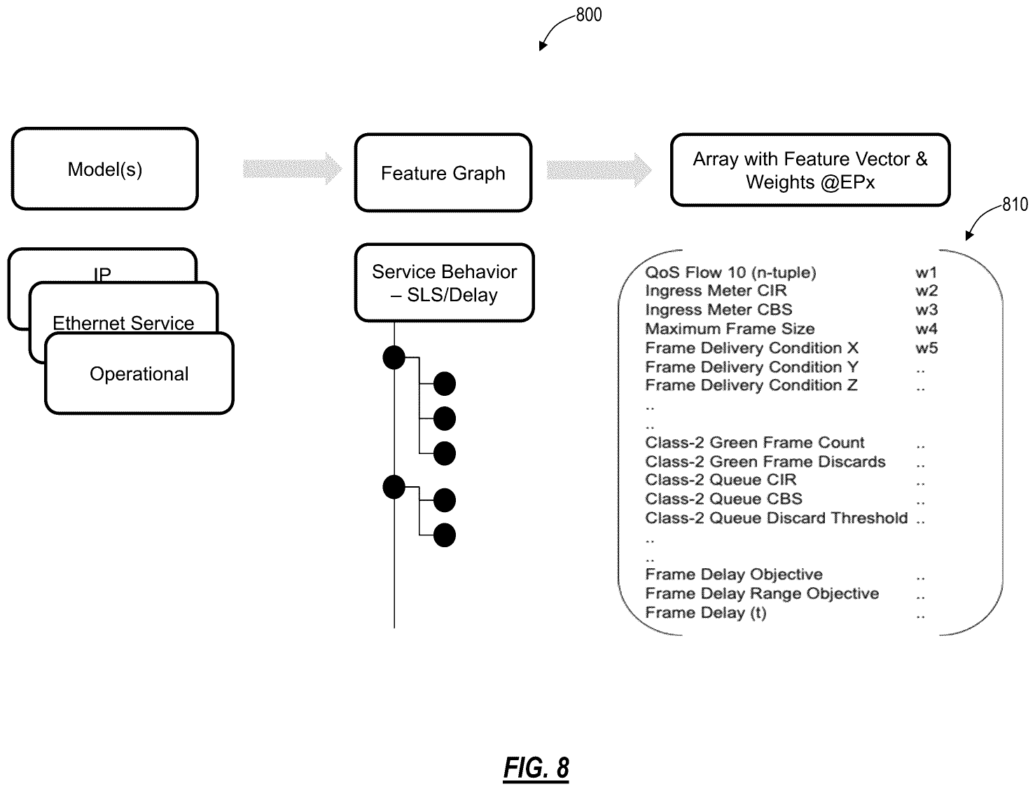

For feature selection, the FGE 710 creates at least one feature graph per service behavior, as shown in 600, to be analyzed by SDIDA pipeline(s). It should be noted that as shown in 600, the attributes 610 are the vertices and the curved lines shown between attributes 620 are the links of the feature graph. As an example, FIG. 8 shows an array 810 with elements for feature vector and relative weights that the FGE 710 could send to the SENSE function 740 for coordinating the collection of the data for those features. Note that the data is collected from the governed system 730 to the SENSE function 740. Not shown in the figures but part of the method, there can be additional elements in the array sent by the FGE 710 such as metadata for the SENSE function 740 to use for further processing.

Relationships between the feature graphs such as for different network layers in a multi-layer network, as well as metadata associated with the features and the feature graphs can exist in this method. Additionally, there can be feature-to-feature and feature graph-to-feature graph relationships, such as that representing the network layer relationships in a multi-layer network domain. The metadata and the relationships could be used to combine and prune any resultant feature graph. Feature graphs 770 can be versioned, stored, and compared via a logically centralized feature information base (FeIB) 780. The implementation of the FeIB 780 may leverage distributed and High Availability (HA) technologies to present the locally centralized view of the features and the feature graphs. The FeIB 780 can be accessed by the FGE 710 while creating new feature graphs as well as when updating the feature vector for the pipelines. One example method could use Topology and Orchestration Specification for Cloud Applications (TOSCA) topology templates to represent the features as TOSCA components and their dependencies via TOSCA Relationship Templates. Any changes in the Sense function 740 due to governance actions on a SDIDA pipeline, including adding or removing SD IDA pipeline, would be used to trigger the Feature Graph Engine to update the feature vector for that pipeline. The FeIBs 780 can be part of or separate from the controllers that hosts the SDIDA pipeline(s).

The method could include emulation/test environments with embedded SDIDA instance(s) for the feature graph engine (FGE) 710 to continuously construct candidate feature graphs and evaluate their correctness against the correctness of the feature graphs 770 actively being used by the SDIDA instance(s) in the autonomous control application(s). This evaluation can also help to inform the FGE 710 to modify the feature graph used by application.

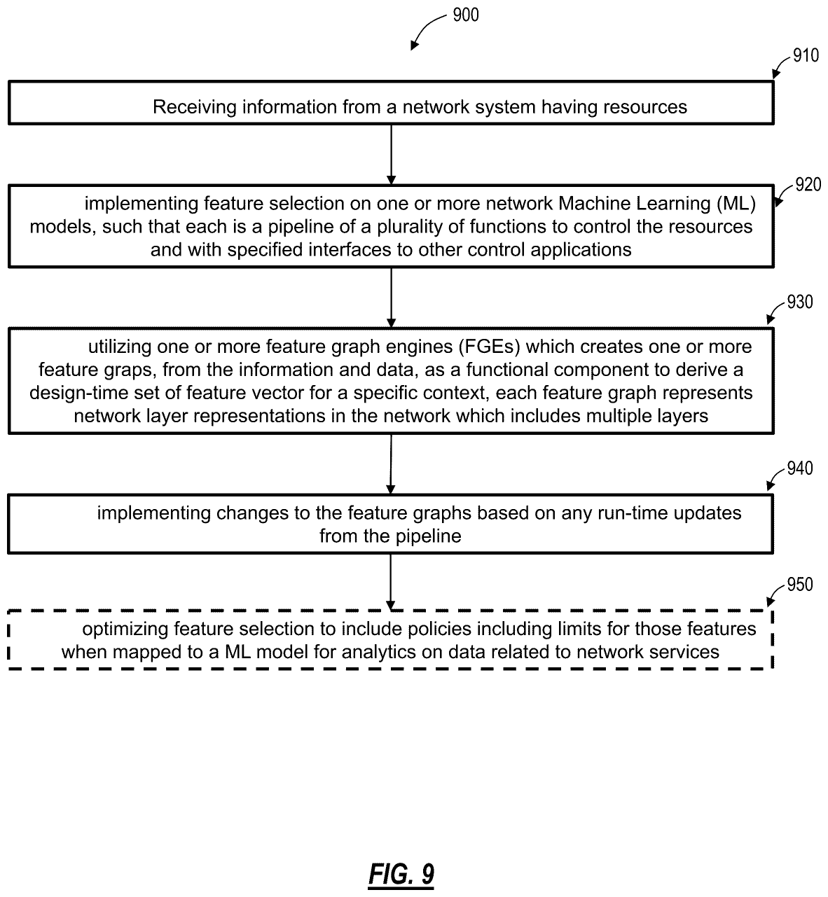

FIG. 9 is a flowchart of a process 900 of the claims as described in this disclosure. The process 900 includes receiving information and data from a network having resources (step 910); implementing feature selection on one or more network Machine Learning (ML) models, such that each is a pipeline of a plurality of functions to control the resources and with specified interfaces to other control applications (step 920); utilizing one or more feature graph engines (FGEs) which creates one or more feature graphs, from the information and data, as a functional component to derive a design-time set of feature vector for a specific context, each feature graph represents network layer representations in the network which includes multiple layers (step 930); and implementing changes to the one or more feature graphs based on any run-time updates from the pipeline (step 940).

The plurality of functions can include sensing, discerning, inferring, deciding, and causing the actions (SDIDA). The ML model can be utilized in the SDIDA pipeline embedded within a controller application. The process 900 can further include optimizing feature selection to include policies including limits for those features when mapped to a ML model for analytics on data related to network services (step 950). The process 900 can further include leveraging the information and data for network services and resources including business and network policies to create and use of the one or more feature graphs for feature selection.

The network can include a plurality of virtual or physical network function elements with links to form various types of network topologies. The process 900 can further performing the utilizing with the information and data for a given service intent and its resources. The one or more feature graphs can include the relative weights to indicate the importance of the features in the ML model. The plurality of functions receive change updates and receive governance feature vector updates

### CONCLUSION

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc. described herein can be used in any and all combinations with each other.

What is claimed is:

1. A non-transitory computer-readable medium having instructions stored thereon for programming a device for performing steps of:
receiving information and data from a network having resources;
implementing feature selection on one or more network Machine Learning (ML) models, such that each is a pipeline of a plurality of functions to control the resources and with specified interfaces to other control applications;
utilizing one or more feature graph engines (FGEs) which creates one or more feature graphs, from the information and data, as a functional component to derive a design-time set of feature vector for a specific context, each feature graph represents network layer representations in the network which includes multiple layers; and
implementing changes to the one or more feature graphs based on any run-time updates from the pipeline.

2. The non-transitory computer-readable medium of claim 1, wherein the plurality of functions include sensing, discerning, inferring, deciding, and causing the actions (SDIDA).

3. The non-transitory computer-readable medium of claim 2, wherein the ML model is utilized in the SDIDA pipeline embedded within a controller application.

4. The non-transitory computer-readable medium of claim 1, wherein the steps further include
optimizing feature selection to include policies including limits for those features when mapped to a ML model for analytics on data related to network services.

5. The non-transitory computer-readable medium of claim 1, wherein the steps further include
leveraging the information and data for network services and resources including business and network policies to create and use the one or more feature graphs for feature selection.

6. The non-transitory computer-readable medium of claim 1, wherein the network includes
a plurality of virtual or physical network function elements with links to form various types of network topologies.

7. The non-transitory computer-readable medium of claim 1, wherein the steps further include
performing the utilizing with the information and data for a given service intent and its resources.

8. The non-transitory computer-readable medium of claim 1, wherein the one or more feature graphs include
the relative weights to indicate the importance of the features in the ML model.

9. The non-transitory computer-readable medium of claim 1, wherein the steps further include
one or more of receiving governance change updates and receiving feature vector updates by the plurality of functions.

10. A method includes steps of:
receiving information and data from a network having resources;
implementing feature selection on one or more network Machine Learning (ML) models, such that each is a pipeline of a plurality of functions to control the resources and with specified interfaces to other control applications;
utilizing one or more feature graph engines (FGEs) which creates one or more feature graphs, from the information and data, as a functional component to derive a design-time set of feature vector for a specific context, each feature graph represents network layer representations in the network which includes multiple layers; and
implementing changes to the one or more feature graphs based on any run-time updates from the pipeline.

11. The method of claim 10, wherein the plurality of functions include sensing, discerning, inferring, deciding, and causing the actions (SDIDA).

12. The method of claim 11, wherein the ML model is utilized in the SDIDA pipeline embedded within a controller application.

13. The method of claim 10, wherein the steps further include
optimizing feature selection to include policies including limits for those features when mapped to a ML model for analytics on data related to network services.

14. The method of claim 10, wherein the steps further include
leveraging the information and data for network services and resources including business and network policies to create and use of the one or more feature graphs for feature selection.

15. The method of claim 10, wherein the network includes
a plurality of virtual or physical network function elements with links to form various types of network topologies.

16. The method of claim 10, wherein the steps further include
performing the utilizing with the information and data for a given service intent and its resources.

17. The method of claim 10, wherein the one or more feature graphs include
the relative weights to indicate the importance of the features in the ML model.

18. The method of claim 10, wherein the steps further include
one or more of receiving governance change updates and receiving feature vector updates by the plurality of functions.

19. An apparatus comprising:
one or more processors and memory storing instructions that, when executed, cause the one or more processors to:
receive information and data from a network having resources,
implement feature selection on one or more network Machine Learning (ML) models, such that each is a pipeline of a plurality of functions to control the resources and with specified interfaces to other control applications,
utilize one or more feature graph engines (FGEs) which creates one or more feature graphs, from the information and data, as a functional component to derive a design-time set of feature vector for a specific context, each feature graph represents network layer representations in the network which includes multiple layers, and
implement changes to the one or more feature graphs based on any run-time updates from the pipeline.

20. The apparatus of claim 19, wherein the plurality of functions include sensing, discerning, inferring, deciding, and causing the actions (SDIDA).
